(19) United States
(12) Patent Application Publication
(10) Pub. No.: US 2014/0165814 A1
(43) Pub. Date: Jun. 19, 2014

(54) "SELF-PLAYING ROBOT GUITAR COMPRISING A BIODEGRADABLE SKIN-LEATHERN FORMED CARCASS AND A BIODEGRADABLE SKIN-LEATHERN FORMED MUSICAL PLECTRUM, AND PROTEIN / AMINO ACIDS"

(71) Applicant: Carlos Alberto Ibanez Vignolo, Miraflores (PE)

(72) Inventor: Carlos Alberto Ibanez Vignolo, Miraflores (PE)

(21) Appl. No.: 13/807,265

(22) PCT Filed: Jul. 26, 2010
(86) PCT No.: PCT/IB2010/002141

§ 371 Date: Dec. 30, 2012

(30) Foreign Application Priority Data
Jul. 30, 2009 (BO) SP-230-09
Aug. 2, 2010 (AR) P100102818

(51) Int. Cl. G10F 1/20

(52) U.S. Cl. CPC G10F 1/20; Y10S 901/01
USPC 84/9; 84/7; 901/1

(57) ABSTRACT

“Self-playing robot guitar comprising a biodegradable skin-leathern formed carcass and a biodegradable skin-leathern formed musical plectrum, and structured protein/amino acids”. The invention relates to a robot having humanoid activity and extremities, having a carcass comprising a chordophone, in particular a guitar, the body of which is optionally skin-leathern formed. Said robot plays instrumental music on and by itself using its own hands thereof. The components of the invention are optionally made of structured proteins/amino acids. In addition, said components are food for animals and plants. Said components are structured, either: I) as is; or II) formed and/or molded, and/or macro- and micro molecularly aligned as is, or structured: A) by thermoforming, and/or B) by electroforming, and/or C) by suddenly abruptly or slowly changing the variation in the outer and/or inner humidity of the processed protein/amino acid and/or by polypeptide alignment of the amino acid chain alone and/or: i) using electrophoresis; and/or it) using electric radIofrequency. The protein optionally contains non proteic [non proteinic/non protean] polymer.

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TRANSLATION OF THE PRESENT INVENTION

This section contains a complete lexicographically and contextually [what is meant to be said] [as some words in Spanish may have one or more than one meaning in English] accurate translation from Spanish to English of the present invention International Filing No. PCT/PE10/02141 [PCT/IB2010/002141] as originally filed:

### DESCRIPTION OF THE INVENTION AND DRAWING

FIG 1 is the only one

### BACKGROUND

The present invention is a “SELF-PLAYING ROBOT GUITAR COMPRISING A BIODEGRADABLE SKIN-LEATHERN FORMED CARCASS AND A BIODEGRADABLE SKIN-LEATHERN FORMED MUSICAL PLECTRUM, AND STRUCTURED PROTEIN/AMINO ACIDS”.

The state of modern technology knows diverse utilitarian robotic forms.

They are also known, plectrums made of diverse materials which are used to play stringed musical instruments [chordophones].

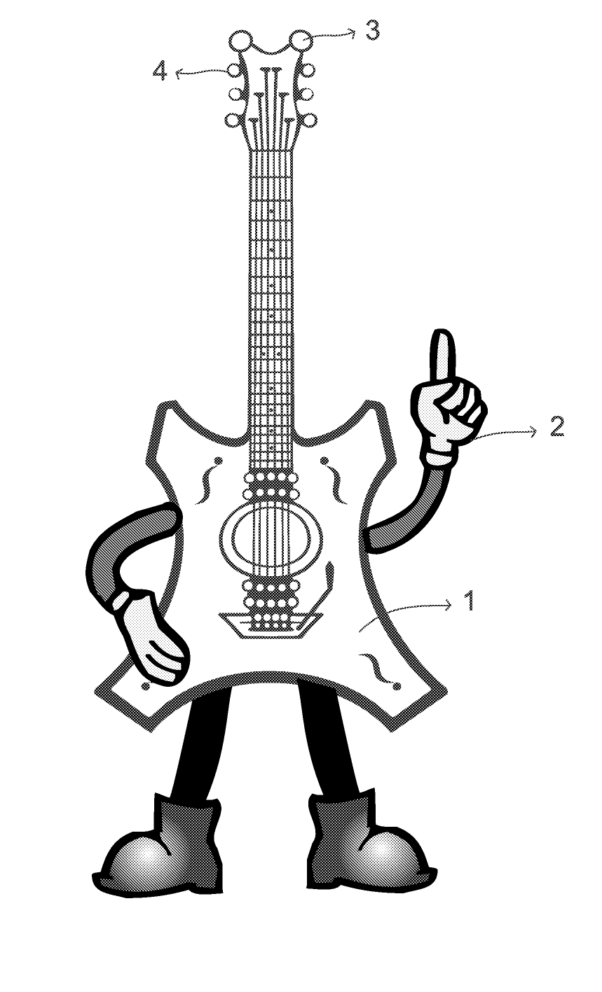

The novelty is that the android robotic guitar [of luthier activity] invention (FIG. 1) plays on itself with its own hands and bionic fingers (2), using as a novelty a biodegradable skin-leathern formed plectrum (not shown), and which further serves as food for animals and plants.

The robot guitar comprises, as a novelty, a body having the characteristical form of a skin-leathern icon (1), and its headstock has two upper self-revolving ear-like (3) tuning keys, and six tuning keys laterally located (4); both comprising known multimodal function (e.g. luminescence, video-audio cameras, displays, among others).

The invention is partially and/or totally biodegradable because its internal and external carcass components, are formed [made] in general manner, partially or totally based upon protein/amino acids.

May be: A) thermoformed, and/or B) electroformed and/or C) by suddenly abruptly changing the variation in the outer and/or inner humidity of the protein/amino acid processed; said protein/amino acid serves additionally and as claimed, as food for animals and plants.

INVENTION, in accordance to claim No. 1, No. 10 and No. 11, wherein the proteic [proteinic/protean]/amino acid material is structured, either; I) as is; or II) formed and/or molded, and/or macro- and micro molecularly aligned as is, or structured by: A) thermoforming, and/or B) electroforming, and/or C) suddenly abruptly or slowly changing the variation in the outer and/or inner humidity of the processed protein/amino acid and/or by polypeptide alignment of the amino acid chain alone and/or: i) using electrophoresis and/or ii) using electric radiofrequency.

The skin-leathern robot guitar meets all functions per se known in the art of technology of a current humanoid robot (Example: walk, jump, run, crawl, climb stairs, roll over itself, listening, speak and sing polylingually [in many languages], among other bio-penta-sensible [5 senses] [human biological senses] applications known per se).

The claims of the invention comprise: a) the skin-leathern robotic guitar carcass (1) with android corporal limbs; b) ear-like multimodal self-revolving tuning keys which the headstock of the robot guitar has; c) the plectrum—guitar pick—made of protein; d) the biodegradability—and food for animals and plants—of the components of the invention, as they are made partially or totally of protein/amino acid, being its use as food for animals and plants, and; e) the musical instrument self-playing auto running capacity of a), by the use of bionic hands (2) which it has.

1. THE INVENTION is a
SELF-PLAYING ROBOT GUITAR COMPRISING
A BIODEGRADABLE SKIN-LEATHERN FORMED CARCASS AND
A BIODEGRADABLE SKIM-LEATHERN FORMED MUSICAL PLECTRUM,
AND
STRUCTURED PROTEIN/AMINO ACIDS”.

2. THE INVENTION according to claim No. 1, comprises a self-playing automat chordophone robot (FIG. 1) which plays musically instrumentally its own strings on itself and by itself.

3. THE INVENTION according to claim No. 2, wherein the chordophone robot comprises as an option having the form of a guitar (FIG. 1).

4. THE INVENTION according to claim No. 2 and No. 3, wherein the chordophone robot (FIG. 1) comprises bionic humanoid android limbs, namely: arms, hands and fingers (2), legs and feet. it also has a body, fingerboard and headstock.

5. THE INVENTION according to claim No. 2 and No. 4, wherein the chordophone robot (FIG. 1) comprises the use of bionic hands and fingers (2) to play and pluck instrumental musically its own strings by itself.

6. THE INVENTION according to claim No. 3, wherein the body carcass of the robot guitar comprises, as an option and as a novelty the form of a skin-leathern icon (1).

7. THE INVENTION according to claim No. 2, No. 3 and No. 4, wherein the headstock comprises two self-revolving earlike upper tuning keys (3).

8. THE INVENTION according to claim No. 7, wherein the tuning keys (3) comprise multimodal capacity:
A) luminescent;
B) of video-audio;
C) irradiant;
D) receptive;
E) projective;
F) electromagnetic, and;
G) of register.
Said multimodal capacity is also comprised in all 6 lateral tuning keys (4).

9. THE INVENTION according to claim No. 1, is partially or totally biodegradable.

10. THE INVENTION according to claim No. 1 and No. 9, is partially or totally biodegradable, as it is made internally and/or externally of protein.

11. THE INVENTION according to claim No. 1 and No. 9, is partially or totally biodegradable, as it is made internally and/or externally of amino acids.

12. THE INVENTION according to claim No. 1, No. 10 and No. 11, wherein the proteic [proteinic/protean]/amino acid material
is structured, either:
I) as is;
or;
II) formed
and/or
molded,
and/or
macro- and micro molecularly aligned as is, or structured:
A) by thermoforming, and/or
B) by electroforming, and/or
C) by suddenly abruptly or slowly changing the variation in the outer and/or inner humidity of the processed protein/amino acid and/or
by polypeptide alignment of the amino acid chain alone
and/or;
i) using electrophoresis; and/or
ii) using electric radiofrequency.

13. THE INVENTION according to claim No. 10, wherein said proteic [proteinic/protean] amino acid component may have optionally incorporated a non proteic [non proteinic/non protean] polymer.

14. THE INVENTION according to claim No. 1, No. 9 and No. 10, comprises a plectrum (not shown) made of protein, optionally may have a non proteic [non proteinic/non protean] component added to the proteic [proteinic/protean] component constitutive of the referred biodegradable plectrum.

15. THE INVENTION according to claim No. 1, wherein the self-playing robot guitar comprising a skin-leathern formed carcass (FIG. 1) has all functions per se known in the art of technology of a current humanoid robot (Example:
walk,
jump,
run,
crawl,
climb stairs,
roll over itself,
listening,
speak and sing polylingually [in many Languages], among other bio-penta-sensible [5 senses] [biological human 5 senses] applications known per se).
